(19) United States
(12) Patent Application Publication
(10) Pub. No.: US 2023/0165755 A1
(43) Pub. Date: Jun. 1, 2023

(54) APPARATUS FOR DRUG PREPARATION, WEIGHING DEVICE INCLUDED IN THE APPARATUS, AND METHOD FOR DRUG PREPARATION

(71) Applicant: BIOVALLEY GROUP S.P.A., Trieste (IT)

(72) Inventors: Paolo Giribona, Trieste (IT); Enrico Merlani, Trieste (IT); Bastiano Deschmann, Trieste (IT); Bostjan Parovel, Trieste (IT)

(21) Appl. No.: 17/922,650

(22) PCT Filed: May 4, 2021
(86) PCT No.: PCT/IB2021/053728

§ 371 Date: Nov. 1, 2022

(30) Foreign Application Priority Data
May 4, 2020 (IT) 102020000009745

(51) Int. Cl. A61J 3/00; B01F 33/841; B01F 35/21

(52) U.S. Cl. CPC A61J 3/00; B01F 33/841; B01F 35/2117; A61J 2200/74

(57) ABSTRACT

Apparatus for drug preparation, comprising: a first rotor adapted to support a first container for the drug and available, in a releasable manner, on the first rotor; a second rotor adapted to support a plurality of second containers, each containing a respective ingredient; pumping means, controllable by a control unit so as to transfer each ingredient from the respective second container into the first container; a weighing device, adapted to weigh the first container and comprising a translation means, a loading cell and at least one spacer adapted to support the first container. In a condition where the spacer supports the first container by decoupling it from the first support element, the loading cell is adapted to continuously generate, during the transfer of the ingredient, a quantity indicative of a weight force.

### CROSS-REFERENCE TO RELATED APPLICATIONS

The present application is filed pursuant to 35 U.S.C. 371 as a U.S. National Phase application of International Patent Application No. PCT/IB2021/053728, which was filed May 4, 2021, claiming priority from Italian patent application no. 102020000009745 filed on Apr. 5, 2020. The entire text of the aforementioned applications is incorporated herein by reference in its entirety.

### CROSS-REFERENCE TO RELATED APPLICATIONS

This patent application claims priority from Italian patent application no. 102020000009745 filed on Apr. 5, 2020, the entire disclosure of which is incorporated herein by reference.

### TECHNICAL FIELD

The present invention relates to an apparatus for drug preparation, a weighing device included in the apparatus, and a method for drug preparation.

### BACKGROUND ART

As is well known, in the field of oncology, the ability to dose chemotherapy drugs precisely and individually for each patient is particularly critical. In fact, chemotherapy drugs used in cancer therapies can generate significant toxic effects, since they have a very narrow window of effective therapeutic concentration (or therapeutic range).

From an operational point of view, there are considerable criticalities in the process of preparation and management of cancer therapies, which is currently still largely based on manual operations by trained operators (e.g. medical staff and/or health professionals). This generates negative consequences in terms of risk for patients and operators, which are difficult to reconcile with an advanced and modern healthcare management.

The main critical elements include the following:
poor precision in the formulation of cancer drugs due to human error;
need to provide in-depth education and specific training to operators in charge of dosing chemotherapy drugs;
difficulty in managing unused quantities of extremely expensive drugs;
high occupational risk for operators involved in the preparation of chemotherapy drugs.

### DISCLOSURE OF INVENTION

Aim of the present invention is to provide an apparatus for drug preparation, a weighing device included in the apparatus, and a method for drug preparation which solve the drawbacks of the known art.

According to the present invention, an apparatus for drug preparation, a weighing device included in the apparatus, and a method for drug preparation, as defined in the appended claims, are realised.

### BRIEF DESCRIPTION OF THE DRAWINGS

For a better understanding of the present invention, a preferred, non-limiting embodiment thereof is described below, provided by way of non-limiting example and in a triaxial Cartesian system XYZ with reference to the accompanying drawings, wherein:

FIG. 1 is a schematic perspective view of an apparatus for the preparation of chemotherapeutic drugs, according to an embodiment;

FIG. 1A is a schematic view from above, in an XY plane, of the apparatus of FIG. 1;

FIG. 1B is a schematic side view, in an XZ plane, of the apparatus of FIG. 1;

FIG. 2 is a schematic perspective view of a weighing device included in the apparatus of FIG. 1, according to an embodiment;

FIG. 3 is a schematic exploded view of the weighing device of FIG. 2;

FIGS. 4A-4B are schematic side views of a detail of the apparatus of FIG. 1, this detail including the weighing device of FIG. 2, according to an embodiment;

FIGS. 5A-5C are schematic side views, in the XZ plane, of the detail of FIGS. 4A-4B in respective operating modes;

FIG. 6 is a block diagram showing a method of implementing the apparatus of FIG. 1.

### BEST MODE FOR CARRYING OUT THE INVENTION

In particular, the figures are shown with reference to the triaxial Cartesian system XYZ defined by an X axis, a Y axis and a Z axis, orthogonal to each other. Next, a gravity acceleration acting along the Z axis is considered.

In the description below, elements common to the various embodiments of the invention are indicated with the same reference numbers.

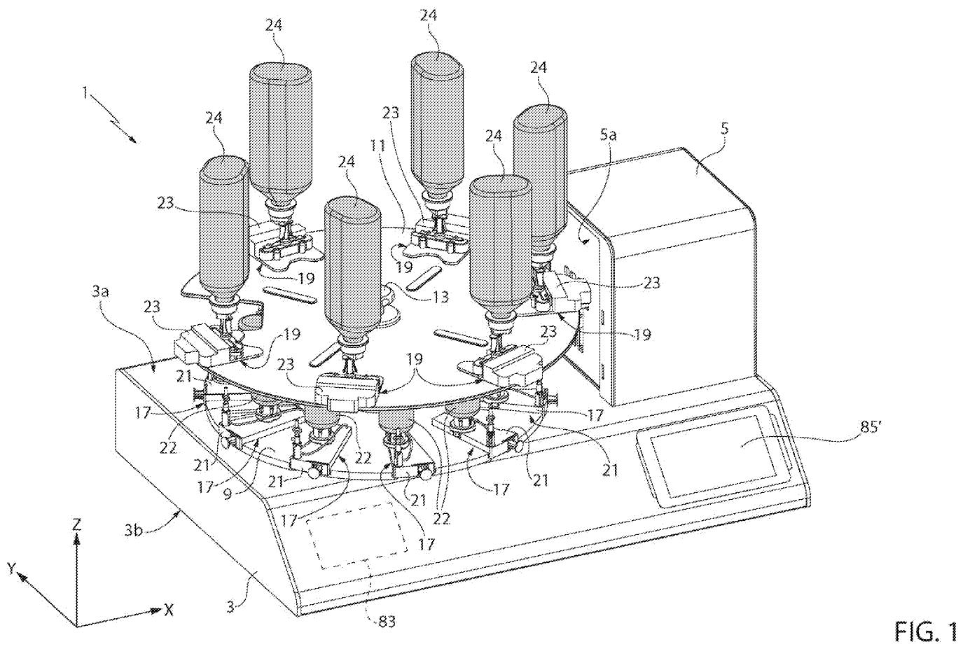

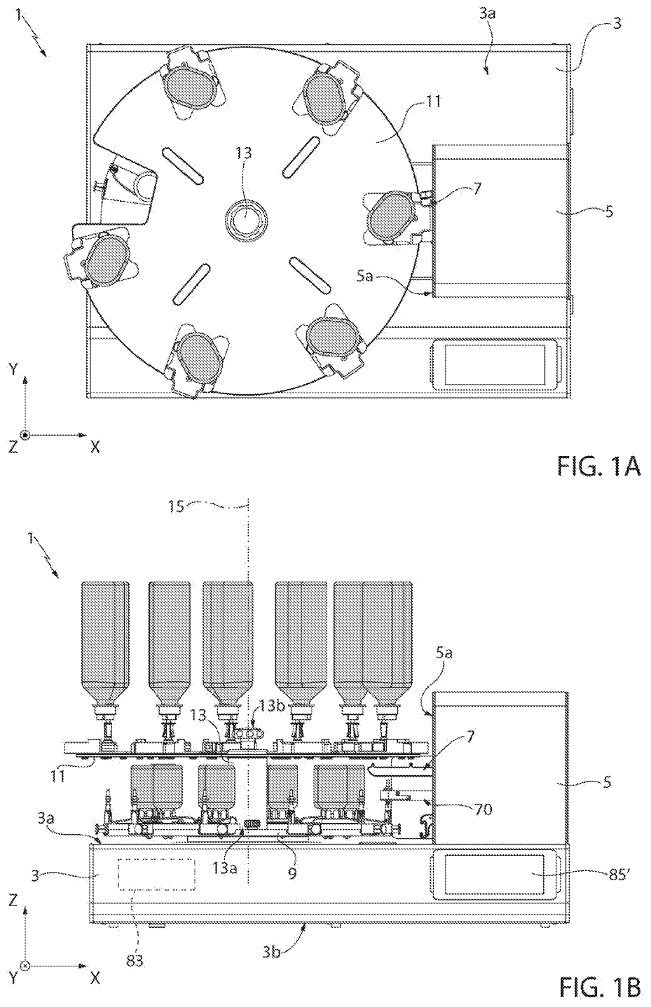

FIGS. 1, 1A and 1B show an apparatus for preparation of chemotherapy drugs (hereafter referred to as “apparatus” and indicated by reference number 1).

The apparatus 1 includes a base 3 configured to be placed on a support (not shown, such as a table, a piece of furniture or a platform), and in particular on a surface (not shown) of the support extending in a XY plane defined by the axes X and Y. The base 3 has an upper surface 3a and a lower surface 3b opposite each other along the Z axis, and extending substantially parallel to each other and parallel to the XY plane.

A first rotor 9 and a second rotor 11 are carried by the base 3 and have a substantially flat shape. In particular, the first and the second rotor 9, 11 have a main extension in the XY plane and have a substantially flat circular shape in the XY plane. The rotors 9, 11 are arranged superimposed one upon the other, are coaxial to each other and are coupled to the base 3 by means of a central stator 13 fixed to the upper surface 3a, extending perpendicularly to said surface 3a and arranged centrally to the rotors 9, 11. In detail, the stator 13 of rectilinear shape has main extension along a rotation axis 15 parallel to the Z axis and includes for example a rod. The stator 13 has a first lower end (not shown) and a second upper end 13b, opposite each other along the Z axis, and is fixed to the base 3 by means of said first end of the stator 13. The rotors 9, 11 are coupled to the stator 13 in a per se known manner, for example by means of respective bearings (not shown), and are configured to rotate with respect to the stator 13. In detail, the stator 13 is arranged centrally with respect to the rotors 9, 11 which rotate, in respective rotation planes (parallel to the XY plane), with respect to the rotation axis 15 (orthogonal to the rotation planes). The rotors 9, 11 are therefore placed at different levels along the Z axis, and in particular the first (lower) rotor 9 faces the upper surface 3a of the base 3 and is at a distance from said upper surface 3a, along the Z axis, a distance which is less than the distance shown by the second (upper) rotor 11. In other words, the first rotor 9 is interposed, along the Z axis, between the base 3 and the second rotor 11.

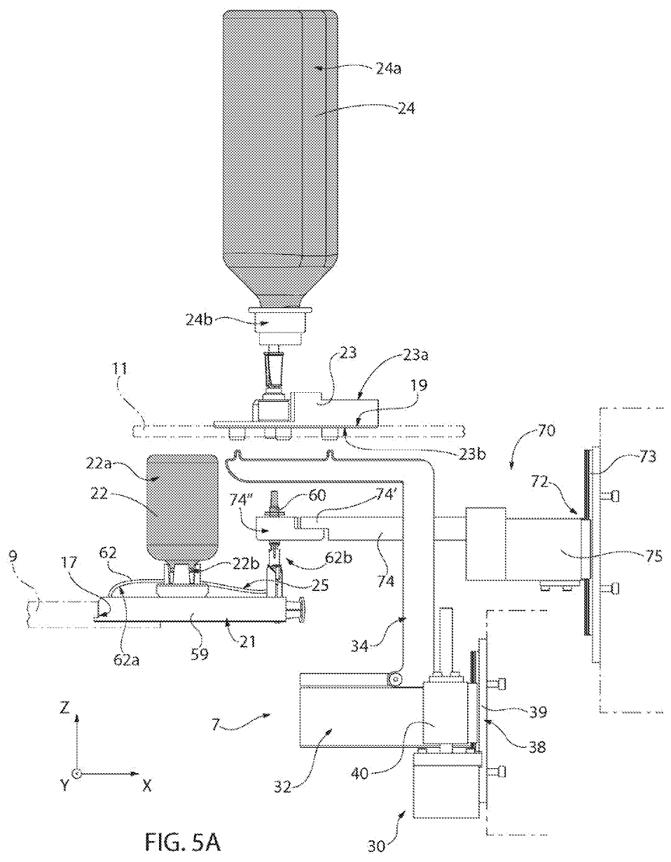

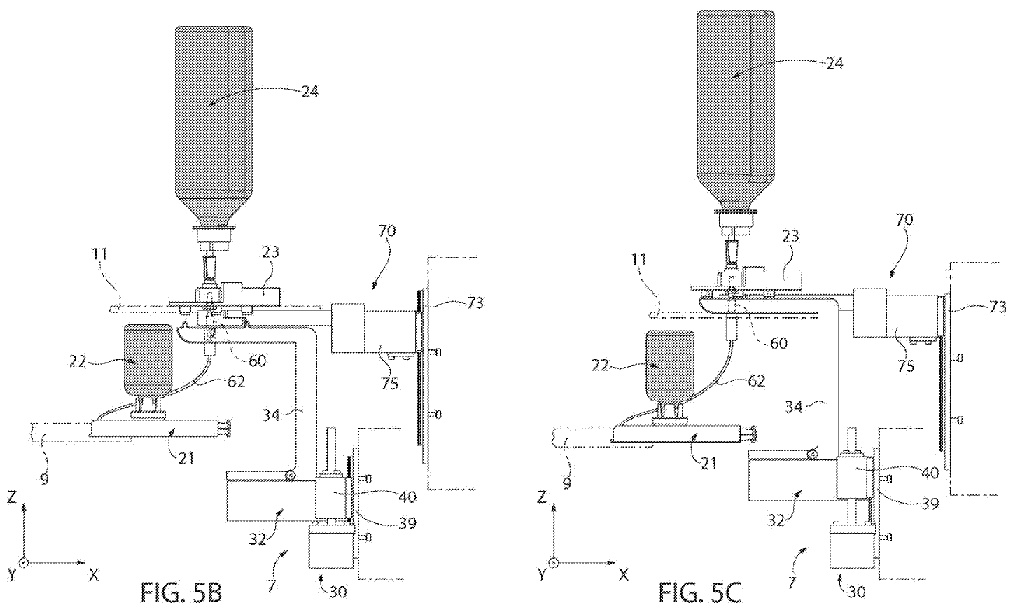

The first rotor 9 includes a plurality of first seats 17 each configured to house a respective fluidic device 21. In particular, as best shown with reference to FIG. 5A, each fluidic device 21 includes a main body 59 comprising a respective first portion shaped so as to releasably couple with (e.g., fit into) the respective first seat 17, for example by interlocking so as to releasably fix the fluidic device 21 to the respective first seat 17. Each fluidic device 21 is coupled to a respective first fluidic container 22 (hereinafter, first container 22). In particular, each first container 22—of known type—includes a first body 22a (e.g., bottle, vial, ampoule) defining a first internal volume and having a through opening closed by a first cap 22b (e.g., of silicone). Each first container 22 is adapted to contain a respective ingredient, and is releasably coupled (e.g., by interlocking) to the respective fluidic device 21 at the cap 22b. In detail, the first containers 22 and the respective fluidic devices 21 are arranged, angularly equally spaced apart between them, at an outer edge of the first rotor 9.

The second rotor 11 includes a plurality of second seats 19 configured to house a respective plurality of supports 23. In particular, as best shown with reference to FIG. 5A, each support 23 can be releasably coupled to the respective second seat 19. Each support 23 includes a first surface 23a and a second surface 23b opposite to each other along the Z axis, and includes a respective second portion (extending at the second surface 23b) shaped so as to releasably fit into the respective second seat 19, for example by interlocking in order to fix the support 23 to the respective second seat 19. The second surfaces 23b of the supports 23 thus face the second rotor 11. Each support 23 is releasably coupled to a respective second fluid container 24 (hereinafter, second container 24) also of known type. In particular, each second container 24 includes a second body 24a (e.g., bottle, vial, ampoule) defining a second internal volume and having a through opening closed by a second cap 24b (e.g., of silicone). Each second container 24 is adapted to contain a respective chemotherapeutic drug to be administered to a respective patient. Each second container 24 is releasably coupled (e.g., by interlocking) to the respective support 23 at the cap 22b. Thus, each cap 22b faces the first surface 23a of the respective support 23. In detail, the second containers 24 and the respective supports 23 are arranged, angularly equally spaced apart between them, at an outer edge of the second rotor 11.

The second rotor 11 has a larger diameter than the respective diameter of the first rotor 9.

An operating device 5 is coupled (in particular, fixed) to the upper surface 3a of the base 3. The operating device 5 has a side wall 5a facing the rotors 9, 11.

The operating device 5 comprises first operating means (not shown), of a type known per se and configured to allow rotation of the rotors 9, 11 with respect to the stator 13. According to an embodiment, the first operating means extend starting from the side wall 5a. Each rotor 9, 11 is independently operated such that the rotors 9, 11 can rotate independently of each other, with different speeds and/or with opposite angular directions (e.g., clockwise and counterclockwise in the top view of FIG. 1B) and with different angular speeds. For example, the first operating means comprise a first and a second motorised gear (not shown, such as gear wheels). The first gear is configured to engage a first toothing fixed to the first rotor 9 (e.g., fixed to a perimeter surface of the first rotor 9); the second gear is configured to engage a second toothing fixed to the second rotor 11 (e.g., fixed to a perimeter surface of the second rotor 11). Alternatively, the first operating means comprise a first and second belt drive configured to cooperate frictionally with the first and, respectively, second rotor 9, 11 (e.g., with the side surfaces of the rotors 9, 11). Alternatively, the first operating means exploit, in a per se known manner, electromagnetic fields to move the rotors 9, 11. Alternatively, the first operating means are included in the base 3 and the stator 13 includes respective drive means to actuate the rotors 9, 11. Alternatively, the first operating means are based on direct drive technologies.

A weighing device 7 for chemotherapeutic drugs is coupled (in particular, fixed) to the operating device 5.

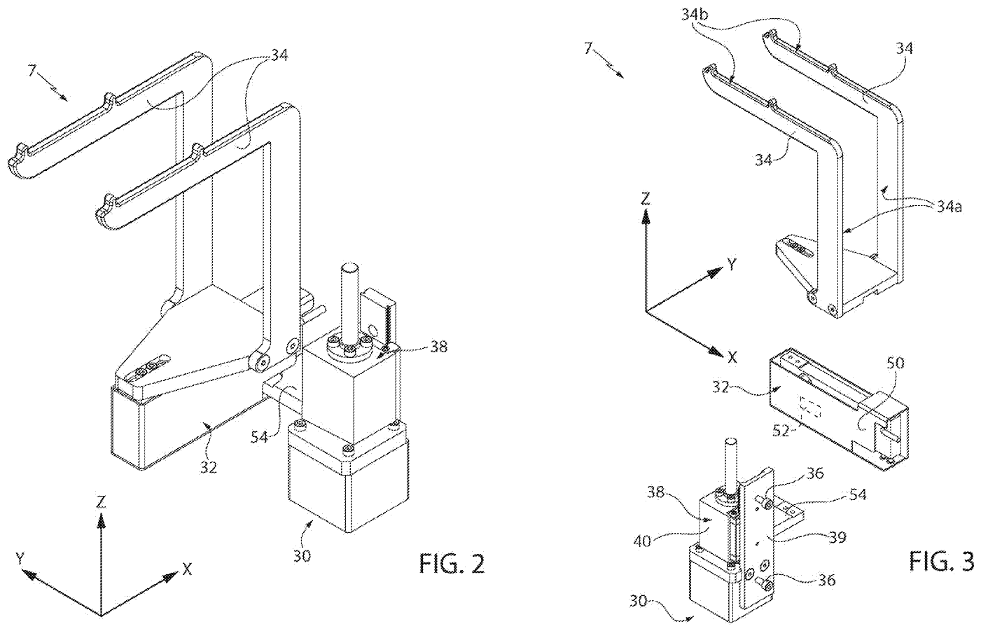

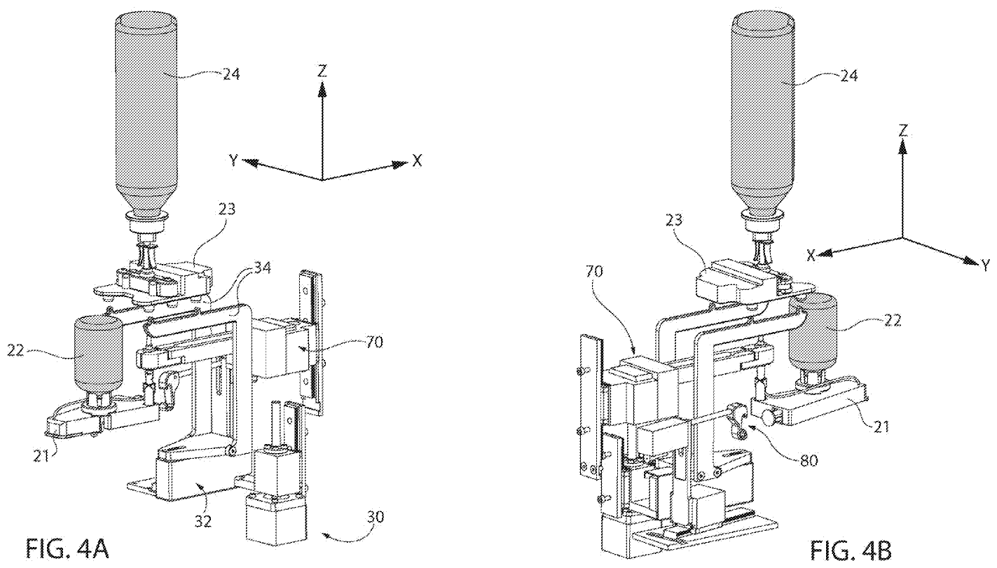

As shown in FIGS. 2-3, the weighing device 7 comprises a support group 30, a loading cell 32 and at least one spacer 34 (in FIG. 2, two spacers 34).

The support group 30 includes at least one fixing element 36 configured to fix the support group 30 to the operating device 5. For example, the fixing element 36 includes a fixing appendage shaped so that it can be coupled in a known manner to (in detail, selectively fitted by interlocking into) a respective fixing seat present in the operating device 5 at the side wall 5a. Alternatively, the fixing element 36 is fixed to the operating device 5 by gluing or welding.

In addition, the support group 30 includes a first translation means 38 configured to displace the loading cell 32 and the spacers 34 with respect to the fixing element 36 and the operating device 5. The first translation means 38 comprises a first guide element 39 and a first movable element 40, which are mutually movable (e.g., cooperating with each other by sliding). In particular, the first guide element 39 is fixed to the fixing element 36 and has a main straight extension parallel to the Z axis. In other words, the first guide element 39 defines a first path along which the first movable element 40 is constrained to move along the Z axis.

The first movable element 40 is moved with respect to the first guide element 39 by means of first motor means (not shown) further included in the support group 30. In particular, the first motor means are fixed to the fixing element 36 or the first guide element 39, and are coupled to the first movable element 40 so as to allow it to be displaced in the first guide element 39. For example, the first motor means include a stepper motor of a known type, or linear actuators based on geared motors, or actuators of the pneumatic or hydraulic type.

The loading cell 32 comprises a body 50 (e.g., of metallic material, such as steel or aluminium) and a plurality of strain gauges 52 fixed to and integral with the body 50. The body 50 allows the strain gauges 52 to be shielded from electromagnetic interferences which can disturb the measurement. According to one embodiment, the strain gauges 52 are made of semiconductor material (e.g., silicon, polycrystalline silicon) or include wires of conductive material (e.g., thin metal film, thick metal film, bonded foil, etc.). The strain gauges 52 are coupled to the body 50 so as to detect a force acting parallel to the Z axis. For example, the strain gauges 52 are mutually arranged in a Wheatstone bridge configuration. In use, said force acting on body 50 parallel to the Z axis causes a deformation (in particular, a compression or a bending), measured along the Z axis, of the body 50. This deformation along the Z axis of body 50 is however small, and is for example less than 0.5% of a length (measured along the Z axis) of the body 50. Since the strain gauges 52 are integral with the body 50, the strain gauges 52 also undergo a respective deformation, and this causes a change in their resistance as a function of said force, as better discussed below.

The loading cell 32 has a first surface 32a and a second surface 32b, opposite each other along the Z axis. A base spacer element 54 is fixed to the first movable element 40 and the second surface 32b of the loading cell 32, thereby coupling the loading cell 32 and the support group 30 together.

In FIGS. 2-3, each spacer 34 is L-shaped and comprises a first portion 34a and a second portion 34b, which are opposite to each other along the Z axis. The spacers 34 are fixed (e.g., by screws, gluing or welding) to the first surface 32a of the loading cell 32 by means of the respective first portions 34a. Each second portion 34b is configured, in use, to be coupled to the second surface 23b of the selected support 23. According to an embodiment, each spacer 34 includes a first part having a main extension parallel to the Z axis, and a second part having a main extension parallel to the X axis. The first and second parts are fixed to each other at respective ends. The first part comprises said first portion 34a, and the second part comprises said second portion 34b. According to a different embodiment, in which there are at least three spacers 34, said spacers 34 have a main extension parallel to the Z axis and are arranged, in view in the XY plane, in a polygonal form (e.g., triangular) so as to support the support 23 and the second container 24.

Accordingly, the spacers 34 (in detail, the second portions 34b), the loading cell 32, the base spacer element 54 and the first movable element 40 are integral with each other, except for the deformation along the Z axis of the body 50.

With reference to FIG. 5A, it is shown that each fluidic device 21 comprises a fluidic connection means 25 adapted to fluidically connect the first container 22 with the second container 24. The fluidic connection means 25 includes a hollow needle 60 (hereinafter, also referred to as needle 60) and a tubular element 62 (e.g., of plastic material) having a first and second end 62a, 62b. The tubular element 62 is flexible and is coupled to the main body 59 through the first end 62a, and to the needle 60 through the second end 62b. The tubular element 62 and the needle 60 are coupled to each other so as to allow a passage of fluid from the main body 59 through the tubular element 62 and the needle 60. The needle 60, as shown below, is movable with respect to the main body 59. In particular, in use the fluidic device 21 and the selected support 23 are mutually arranged so that the needle 60 is facing the second cap 24b along the Z axis.

As shown in FIGS. 1B, 5A, the operating device 5 further comprises second operating means 70, configured to move the needle 60 by displacing it upwards (thus towards the rotor 11 along the Z axis) so as to couple the needle 60 of the fluidic device 21 with the second cap 24b of the second selected container 24. In particular, the second operating means 70 extend starting from the side wall 5a, and include a second translation means 72 and a gripping means 74, operatively coupled to each other.

The gripping means 74 is configured to couple to the needle 60, allowing it to move as mentioned above. In particular, the gripping means 74 includes two arms 74′ having respective end portions 74″. For example, the arms 74′ have a main extension parallel to the X axis, are arranged so that the needle 60 is placed, parallel to the Y axis, between these end portions 74″, and the arms 74′ can be operated so that they are closed around the needle 60 and allow it to be seized. In a first operating condition, the end portions 74″ are decoupled from each other (they are arranged with each other along the Y axis at a first distance D₁); and in a second operating condition, the end portions 74″ are coupled with each other (they are arranged with each other along the Y axis at a second distance D2 less than the first distance D₁). In particular, in the second operating condition, the end portions 74″ abut with the needle 60, which is therefore integral with the end portions 74″ by friction and/or interlocking with the latter. The arms 74′ are operated in a per se known manner (e.g., by means of gears, by means of a motor, e.g., a stepper motor, or by means of at least one translation means analogous to the translation means 38 and defining a respective path parallel to the Y axis).

The second translation means 72 is configured to displace the needle 60 with respect to the main body 59 towards the second rotor 11. The second translation means 72 comprises a second guide element 73 and a second movable element 75, which are movable between them (e.g., cooperating with each other by sliding). In particular, the second guide element 73 is fixed to the side wall 5a and has main extension parallel to the Z axis. In other words, the second guide element 73 defines a second path along which the second movable element 75 is constrained to move, said second path being linear and parallel to the Z axis. In detail, the second guide element 73 extends, along the Z axis, from the level of the needle 60 to the level of the cap 24b.

The second movable element 75 is moved in the second guide element 73 by means of second motor means (not shown). In particular, the second motor means are fixed to the side wall 5a or to the second guide element 73, and are coupled to the second movable element 75 so as to allow it to be displaced in the second guide element 73 from a rest position to an activation position. For example, the motor means include a second stepper motor, or linear actuators based on geared motors, or actuators of the pneumatic or hydraulic type.

The subsequent actions of the gripping means 74 and of the second translation means 72 thus make it possible to seize the needle 60 arranged in the rest position and, subsequently, to displace it parallel to the Z axis until bringing it into the activation position in which the needle 60 is inserted into the second cap 24b, thus allowing a fluidic connection between the first container 22 and the second container 24.

The operating device 5 further comprises third operating means 80, configured to operate the fluidic device 21 so as to allow a passage of fluid between the first container 22 and the needle 60. In particular, the third operating means 80 are controllable to pump fluid from the first container 22 to the second container 24, through the needle 60.

A control unit 83 (such as a processor, ASIC, PCB, or dedicated controller) is also operatively coupled to the apparatus 1 and is configured to command the apparatus 1, and in particular to command the weighing device 7, the first operating means, the second operating means 70, and the third operating means 80. In particular, the apparatus 1 includes the control unit 83 (e.g., the control unit 83 is included in the base 3 or in the operating device 5).

In detail, the first movable element 40 is controllable by the control unit 83 in a first position of said first path so that the spacer 34 does not support the second container 24, and in a second position of said path so that the spacer 34 supports the second container 24 so as to raise it and decouple it from the second rotor 11.

Furthermore, the loading cell 32 is controllable by the control unit 83 so as to continuously generate, while the spacer 34 supports the second container 24 and the selected ingredient is transferred from the respective first container 22 into the second container 24, an indicative quantity of said force. In this description, “continuously” means that the loading cell 32 has a high “Output Data Rate” (ODR) (e.g., greater than 10 readings/s) so as to allow a dynamic, real-time measurement of the weight of the ingredient as it is inserted in the second container 24. In particular, each pumping phase performed by the third operating means 80 has a duration ranging between about 5 s and about 20 s, and an acquisition time of the loading cell 32 (equal to the inverse of the ODR) is less than the duration of the pumping phase, and for example is equal to 2% of an average of the duration of the pumping phase. Furthermore, a pumping speed is modified and updated based on the measurement of the loading cell 32, and thus as a function of the quantity of the ingredient transferred into the second container 24 (similarly, the quantity of the ingredient still to be transferred into the second container 24). In fact, the closer the weight of the ingredient, while being inserted in the second container 24, moves to a target weight (corresponding to a target volume of the ingredient to be transferred into the second container 24), the more the pumping speed is decreased until a minimum pumping speed is reached. This ensures an optimal pumping time resolution.

Optionally, the apparatus 1 further comprises first interface means 85′, for example including at least one between a display device (such as a screen, also of the touch screen type) and a plurality of buttons. For example, the first interface means 85′ are included in the base 3 or in the operating device 5. In addition, the apparatus 1 may also be operatively coupled (e.g., wired, via the Internet or electromagnetically via antennas) to second interface means 85″ (not shown), such as external electronic devices (e.g., computer, smartphone, keyboard or mouse). In particular, the second interface means 85″ may include a printing apparatus, such as a label printer. In particular, the first interface means 85′ and the second interface means 85″ are operatively coupled to the control unit 83.

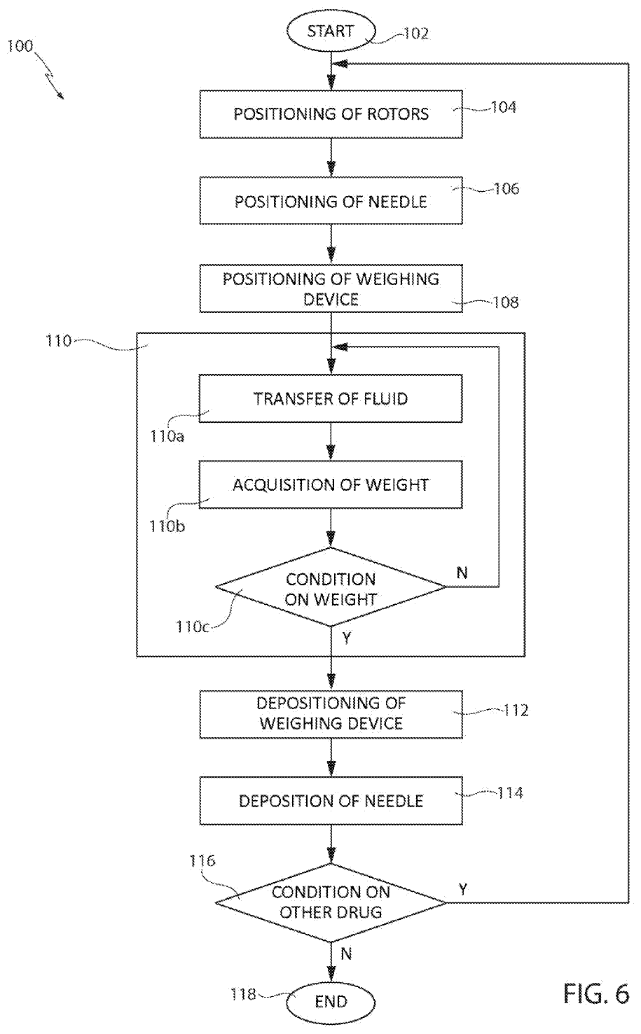

With reference to FIGS. 5A-5C and 6, a method for operating 100 the apparatus 1, implemented via the control unit 83, is described.

The operating method 100 starts at step 102. Initially, the supports 23, the fluidic devices 21 and the containers 22, 24 are not coupled to the apparatus 1. At step 102, the device 1 is turned on and acquires prescription data which are entered, either by the operator or in an automated manner, via the first interface means 85′ and/or second interface means 85″ (e.g., a server of a hospital facility comprising an archive with patient data). The prescription data are indicative of the prescription to be followed, i.e. the chemotherapy drug to be prepared for the patient under consideration. In particular, the prescription data include:
patient's personal data (name, surname, date of birth, any additional identifying information);
active substance (or ingredient) of the chemotherapeutic drug to be prepared;
quantity of active substance (or ingredient) prescribed;
trade name and size (e.g. expressed in mL) of the second container 24 adapted to contain the chemotherapeutic drug;
type of second container 24 (e.g. bag, syringe, elastomer);
any substance already present in the second container 24 (e.g. in the case of bags) and relative volume; and
delivery times.

For example, this quantity of active substance of the chemotherapy drug is delivered in weight Wₚₐ (e.g., in mg), and is converted into a corresponding weight W_{fc} of commercial chemotherapy drug (e.g., in mg) using the following relationship:

$${P}_{fc} = \frac{{P}_{pa}}{{c}_{fc}} \cdot {d}_{fc}$$

where W_{fc} is the weight (in mg) of the chemotherapy drug to be dosed and administered to the patient under consideration, Wₚₐ is the weight (in mg) of the active substance (or ingredient), d_{fc} is a density (in mg/mL) of the chemotherapy drug and cfc is a concentration of the active substance (or ingredient) in the chemotherapy drug.

In step 102, a set-up of the apparatus 1 is also performed, for example performed in a controlled atmosphere (e.g., under a hood) and including:
disinfection and cleaning of apparatus 1, of the supports 23, of the fluidic devices 21 and of the containers 22, 24; and
assembly of the supports 23, of the fluidic devices 21 and of the containers 22, 24 to the apparatus 1.

In particular, said assembly of the supports 23, of the fluidic devices 21 and of the containers 22, 24 to the apparatus 1 is performed by the operator or in an automated manner, and allows loading all the materials and/or objects necessary for the preparation of the specific chemotherapeutic drug. The supports 23, the fluidic devices 21 and the containers 22, 24 are identified by reading respective identification codes associated therewith. In particular, the supports 23, the fluidic devices 21 and the containers 22, 24 have either respective labels glued thereto and including respective barcodes, or respective radio frequency identification (“RFID”) labels, suitable for identifying them. In detail, the fluidic devices 21 and the containers 22 are coupled to the first rotor 9, and the supports 23 and the containers 24 are coupled to the second rotor 11, as previously described.

This is followed, at a step 104, by a positioning of the rotors 9, 11, shown in FIG. 5A. In detail, the second rotor 11 rotates, by means of the first operating means, so as to bring the second selected container 24 closer to the operating device 5, said second container 24 being adapted to contain the chemotherapeutic drug of the patient under consideration. Furthermore, the first rotor 9 rotates, by means of the first operating means, so as to bring the selected first container 22 closer to the operating means 5, said first container 22 containing the ingredient to be inserted into the second container 24 to make the chemotherapeutic drug for the patient under consideration. The selected containers 22, 24 are therefore overlapping and at least partially aligned with each other parallel to the Z axis and face the side wall 5a of the operating device 5.

As shown in FIG. 5B, at a step 106, consecutive to step 104, the second operating means 70 couple the needle 60 of the selected fluidic device 21 with the second selected container 24, said needle 60 is used to achieve fluidic communication between the containers 22, 24. In addition, the third operating means 80 are coupled to the fluidic device 21.

As shown in FIG. 5C, at a step 108, consecutive to step 106, the weighing device 7 is positioned in relation to the support 23 and to the second container 24, so as to allow the weighing thereof. In particular, the support group 30 translates, along the Z axis, the loading cell 32 and the spacers 34 in the direction of the support 23. The action of the support group 30 ends when the support 23 is decoupled from the second rotor 11. In other words, the support group 30 places the second portion 34b in contact with the second surface 23b of the support 23, making the spacers 34 and the second container 24 integral with each other, and also translates the second container 24 upwards along the Z axis starting from the second rotor 11 in the opposite direction with respect to the base 3, thus decoupling the support 23 and the second container 24 from the second rotor 11. According to an embodiment, the first translation means 38 stops its action (i.e. the first movable element 40 is blocked with respect to the first guide element 39, is static with respect to the latter) when the support 23 (in detail, the second surface 23b) and the second rotor 11 are distant from each other along the Z axis by a predefined distance D_{predef}, for example ranging between 5 mm and 10 mm. The predefined distance D_{predef} is greater than a deformation, measured along the Z axis, which the loading cell 32 may undergo when subjected to that force. In fact, assuming a density of the chemotherapeutic drug of less than about 1.5 g/cm³ and considering the second container 24 full of said chemotherapeutic drug (i.e. volume of chemotherapeutic drug equal to the second internal volume), the maximum deformation of the loading cell 32 due to the weight of the second container 24 is in any case less than about 0.5 mm. Accordingly, although during such filling, the second container 24 approaches the second rotor 11 (i.e., they are less distant between them than the predefined distance D_{predef}, due to the increasing weight of the second container 24), the loading cell 32 measures the weight of the second container 24 with no risk of incorrect data acquisition due to the contact between the support 23 and the second rotor 11.

Furthermore, in step 108, a tare weight Wₜₐᵣₑ is acquired via the loading cell 32 and when the support 23 and the second rotor 11 are decoupled from each other (analogous to what is described below). In particular, the tare weight Wₜₐᵣₑ is a function of a weight of the support 23 and of a first weight of the second container 24, measured before the transfer of the ingredient from the first container 22 to the second container 24.

Furthermore, optionally, at step 108 the second operating means 70 further move the needle 60 parallel to the Z axis towards the second container 24 supported by the spacer 34, to achieve fluidic communication between the containers 22, 24. The needle 60 is threaded into, for example, the second cap 24b by piercing it. In particular, said further translation is performed if the translation of the second container 24, parallel to the Z axis and on the opposite side to the second rotor 11, causes the needle 60 to decouple from the second container 24, thus making said further translation necessary to keep the containers 22, 24 in fluidic communication with each other when the third operating means 80 are operated.

At a step 110, consecutive to step 108, fluid is transferred from the first container 22 to the second container 24 is made. In particular, step 110 comprises, consecutively to each other, a step 110a, a step 110b and a step 110c which are performed iteratively (iterations 1≤i≤N).

In step 110a, consecutive to step 108, a part of the ingredient is transferred from the first container 22 to the second container 24, by means of the third operating means 80. This part of the ingredient is transferred at the ith iteration and is less than a total quantity of ingredient contained in the first container 22. For example, the first container 22 may contain 50 mL of the ingredient, and that part of the ingredient is equal to about 0.5 mL.

At step 110b, consecutive to step 110a, said quantity (in detail, analogue electrical signal) indicative of an instantaneous gross weight W_{inst,gross} is acquired from the control unit 83 and via the loading cell 32. This gross instantaneous weight W_{inst,gross} corresponds to the ith iteration and is a function of the weight of the support 23 and of a second weight of the second container 24, measured during the transfer of the ingredient from the first container 22 to the second container 24. This quantity is processed (e.g., amplified and converted into a corresponding digital signal) to generate a processed quantity, which is associated with the corresponding instantaneous gross weight W_{inst,gross} (e.g., by linear conversion using a multiplication factor, or using a “lookup table”). Furthermore, a net instantaneous weight W_{inst,net} is calculated as a function of the gross instantaneous weight W_{inst,gross} and the tare weight Wₜₐᵣₑ. In particular, the relation W_{inst,net}=W_{inst,gross}−Wₜₐᵣₑ applies. The net instantaneous weight W_{inst,net} is indicative of the total quantity of ingredient transferred from the first container 22 to the second container 24 up to the instant of this measurement (i.e. from i=1 to the currently executed ith iteration).

At step 110c, consecutive to step 110b, a condition on the net instantaneous weight W_{inst,net} occurs. In particular, it is determined whether the net instantaneous weight W_{inst,net} satisfies a predefined relationship with a threshold (threshold weight W_{threshold}). In more detail, it is checked whether the net instantaneous weight W_{inst,net} is equal to or greater than the threshold weight W_{threshold}.

If the net instantaneous weight W_{inst,net} is less than the threshold weight W_{threshold} (output “N” from step 110c), an additional part of the ingredient is transferred from the first container 22 to the second container 24 (i=i+1), i.e., step 110a is performed again.

If the net instantaneous weight W_{inst,net} is equal to or greater than the threshold weight W_{threshold} (output “S” from step 110c), step 112 is carried out. Optionally, a notification is sent to the operator via the first interface means 85′ (e.g., alert message on termination of chemotherapy drug preparation).

In step 112, consecutive to step 110c via output “S”, the weighing device 7 is decoupled from the support 23 and the second container 24. In particular, the support group 30 translates, along the Z axis, the loading cell 32 and the spacers 34 downwards (i.e. in the direction of the base 3 along the Z axis), performing a reverse movement to that described with reference to step 108.

At a step 114, consecutive to step 112, the second operating means 70 displace the needle 60 downwards (i.e. in the direction of the base 3 along the Z axis) and decouple the needle 60 from the second container 24, interrupting the fluidic communication between the containers 22, 24. In other words, a reverse movement to that described with reference to step 106 is made. In addition, the third operating means 80 are decoupled from the fluidic device 21.

At step 116, consecutive to step 114, a condition on the composition of the chemotherapeutic drug to be prepared is verified. In particular, it is determined whether other ingredients (located in respective first containers 22 other than the previously selected first container 22) need to be added to the second container 24 to obtain the chemotherapeutic drug.

If further ingredients are needed for the preparation of the chemotherapeutic drug (output “S” from step 116), the positioning of the rotors 9, 11 is performed again, thus returning to step 104. In particular, the first rotor 9 is operated to select the first container 22 of interest.

If no further ingredients are needed for the preparation of the selected chemotherapeutic drug (output “N” from step 116), the operating method 100 ends at a step 118, wherein, for example, the device 1 is turned off or will be awaiting a further order for a different preparation.

Furthermore, at step 118, a disassembly of the supports 23, of the fluidic devices 21 and of the containers 22, 24 from the apparatus 1 may be performed by the operator or in an automated manner, in order to prepare the apparatus 1 to perform step 102 again.

Furthermore, at step 118, an identification label for the second container 24 may be generated, for example, by means of said printing apparatus (included in the second interface means 85″ and operatively coupled to the control unit 83). In particular, such a label may include, for example, a barcode label or an RFID label. Such a label is adapted to be coupled (e.g., glued or fixed) to the second container 24, and is indicative of data such as the nature of the chemotherapeutic drug contained in the second container 24 (e.g., chemical composition and/or active substance contained) and/or an identifier of the patient to whom said chemotherapeutic drug is to be administered.

From an examination of the characteristics of the invention realised according to the present invention, the advantages that it allows obtaining are evident.

The apparatus 1 is an automated system for the preparation of anticancer drugs, capable of overcoming the critical elements connected with the manual preparation thereof and of ensuring a substantial increase in the quality of cancer therapies. In fact, the apparatus 1 allows a significant increase in formulation accuracy, a significant reduction of chemical contamination of the environments intended for the preparation of such drugs and a drastic reduction of the professional risk for the healthcare workers assigned thereto.

In addition, the apparatus 1 implements, via the control unit 83, a computerised procedure for managing chemotherapy preparations, for use for example by hospital pharmacies. This computerised procedure can be interfaced with a hospital information system (if any) through standard communication protocols.

The apparatus 1 is an automated table-top device, which can be easily inserted into a laminar flow hood for chemotherapy. For example, the apparatus 1 may be operated under a vertical laminar flow hood of ISO class 5, which in turn is placed in an ISO class 8 air-controlled environment.

Advantageously, the communication between the control unit 83 and the second interface means 85″ takes place in wireless mode, in order to eliminate any wired connection between a sterile interior of the hood in which the apparatus 1 is positioned and the external environment.

In particular, the apparatus 1 allows the automatic dosage of the antineoplastic drug in liquid or reconstituted phase, by adopting a closed circuit fluidic system able to guarantee sterility during the transfer of the chemotherapeutic drug from the first container 22 to the second container 24, and the absence of contamination of the surrounding environment.

In detail, the accuracy of the dosage of the chemotherapeutic drug is guaranteed by the operating method 100 which operates in real time to control this dosage via the weighing device 7. Indeed, measuring the weight of the chemotherapy drug in real time makes it possible to achieve better dosage accuracies than those currently achievable. In particular, this ensures dosing errors of less than 0.1%, which is more than one order of magnitude less than the accuracy allowed by the European Pharmacopoeia in manual preparations.

In addition, the chemotherapy drug is dosed directly into the second containers 24, which are the final containers intended for administration to the patient. This avoids the need for further and subsequent handling, which could be a source of contamination for healthcare workers and patients.

Each second container 24 is identified by a code (e.g. QR) with the details of the chemotherapy drug preparation and of the patient for whom it is intended. This information is therefore verifiable at the time of administration in order to prevent possible accidental exchange of drugs.

The main advantages obtainable by means of apparatus 1 are:
increase in the accuracy of chemotherapy drug dosing;
increase in the sterility level of injectable preparations;
reduction of cytostatic contamination of the surrounding environment (laboratory, pharmacy, hospital);
more safety for hospital pharmacy workers (reduced needlestick injuries, reduction of hand fatigue pathologies, etc.);
more patient safety thanks to the reduction of the risk of accidental drug and/or patient exchanges, or incorrect dosing;
optimisation of the use of cytostatic drugs, with a reduction in the significant costs related to discarding unused cytostatic drugs.

It is clear that changes and variations can be made to the invention described and shown herein without departing from the protection scope of the present invention, as defined in the appended claims.

In particular, the strain gauges 52 of the loading cell 32 may be based on technologies other than the resistive technology discussed above. For example, the strain gauges 52 may be made of piezoelectric material, or capacitive strain gauges, or inductive strain gauges, or optical strain gauges (e.g., laser optical strain gauges), or fibre optic strain gauges, or acoustic strain gauges.

In addition, the first operating means can also be arranged in the base 3 instead of in the operating device 5.

The translation means 38 can be commanded by the control unit 83 in closed-loop mode. In particular, during the transfer of the ingredient from the first to the second container 22, 24, the translation means 38 is controlled so that the support 23 and the second rotor 11 are distant from each other by a fixed distance D_{fixed}, less than the predefined distance D_{predef}. In fact, the deformation of the loading cell 32 (e.g., based on magnetic compensation technology) along the Z axis due to the increasing weight of the second container 24 is compensated by a respective further displacement (in the opposite direction) of the first movable element 40 in the guide element 39, so that the distance between the support 23 and the second rotor 11 remains unchanged, and equal to the fixed distance D_{fixed}.

The actions performed in steps 106, 108 can also be performed simultaneously with each other.

The first movable element 40 and the second surface 32b of the loading cell 32 may also be directly fixed to each other.

In addition, the second rotor 11 may be replaced by a support structure (not shown) fixed to the base 3 (therefore not rotatable) in the event that only a second container 24 can be coupled to the apparatus 1. In such a case, after the ingredients have been added to the second container 24 to create the chemotherapeutic drug in a manner similar to that described above, said second container 24 is removed and replaced, automatically or manually, with a further second container 24 to proceed to a further preparation of chemotherapeutic drug.

The apparatus 1 may also be used in the preparation of drugs other than chemotherapeutic drugs, for example injectable drugs such as monoclonal antibodies, cytotoxics, hormones and hormone antagonists, antimitotics, alkylating agents, antibiotics.

1. An apparatus (1) for drug preparation starting from a plurality of ingredients, the apparatus (1) being characterized in that it comprises:
a first support element (11), configured to support at least a first container (24) adapted to contain the drug and arrangeable, in a releasable manner, on the first support element (11);
a second support element (9), configured to support a plurality of second containers (22), each second container (22) being adapted to contain a respective said ingredient;
a control unit (83);
pumping means (21, 70, 80), couplable with the first container (24) and to each of the second containers (22) and operatively coupled with the control unit (83), said pumping means (21, 70, 80) being controllable by the control unit (83) so as to fluidically connect, in reciprocal succession between them, the first container (24) with each second container (22), and so as to transfer, at least partially, each ingredient from the respective second container (22) into the first container (24); and
a weighing device (7), operatively coupled with the control unit (83) and configured to weigh the first container (24), said weighing device (7) comprising:
a first guide element (39), defining a first path along a first axis (Z),
a first movable element (40), coupled with the first guide element (39) so as to move along said first path,
a loading cell (32), having a first surface (32a) and a second surface (32b) opposite each other along the first axis (Z), fixed to the first movable element (40) through the second surface (32b) and configured to measure a weight force acting on the first surface (32a), and
at least one spacer (34), having a first end (34a) fixed to the first surface (32a) of the loading cell (32) and configured to support the first container (24) at a second end (34b) opposite to the first end (34a) along the first axis (Z),
wherein the first movable element (40) is controllable by the control unit (83) in a first position of said first path so that the spacer (34) does not support the first container (24), and in a second position of said path so that the spacer (34) supports the first container (24) so as to decouple it from the first support element (11), and
wherein the loading cell (32) is controllable by the control unit (83) so as to generate continuously, while the spacer (34) supports the first container (24) and the ingredient is transferred from the respective second container (22) into the first container (24), an indicative quantity of said weight force.

2. The apparatus according to claim 1, further comprising a base (3) having a surface (3a), orthogonal to the first axis (Z), to which the first support element (11) and the second support element (9) are coupled and to which the first guide element (39) is fixed,
the first support element (11) and the second support element (9) extending parallel to said surface (3a) and being arranged coaxially to each other with respect to a rotation axis (15) parallel to the first axis (Z),
the second support element (9) being axially interposed, relative to the rotation axis (15), between the first support element (11) and the surface (3a), and being rotatable relative to the base (3) about the rotation axis (15).

3. The apparatus according to claim 2, wherein the first support element (11) is rotatable relative to the base (3) about the rotation axis (15) and is configured to support, in a releasable manner, the first container (24) and at least a further first container (24).

4. The apparatus according to claim 3, further comprising first operating means controllable by the control unit (83) and configured to rotate, independently of each other, the first support element (11) and the second support element (9) relative to the base (3) about the rotation axis (15), so that a first selected container (24) and a second selected container (22) are arrangeable in respective angular positions so that they face the pumping means (21, 70, 80).

5. The apparatus according to claim 2, wherein the pumping means (21, 70, 80) comprise:
a tubular and flexible fluidic connection means (25) having a first end portion (62a) and a second end portion (62b, 60), the fluidic connection means (25) being couplable with the second selected container (22) through the first end portion (62a) and to the first container (24) through the second end portion (62b, 60); and
second operating means (70) including:
a second guide element (73), fixed to the base (3) and defining a second path parallel to the first axis (Z);
a second movable element (75), coupled with the second guide element (73) so as to move along said second path; and
gripping means (74), fixed to the second movable element (75) and controllable by the control unit (83) to couple, in a releasable manner, with said second end portion (62b, 60),
wherein the pumping means (21, 70, 80) are controllable by the control unit (83) to couple, via the gripping means (74), with the second end portion (62b, 60) and, subsequently, to move the second end portion (62b, 60) along the second path so as to couple the second end portion (62b, 60) with the first container (24) thus creating a connection with passage of fluid.

6. The apparatus according to claim 5, wherein the pumping means (21, 70, 80) further comprise third operating means (80) controllable by the control unit (83) to pump, when said second end portion (62b, 60) is coupled with the first container (24), each ingredient from the respective second container (22) into the first container (24) through the fluidic connection means (25).

7. The apparatus according to claim 1, wherein the control unit (83) is operatively coupled with a printing apparatus (85″) controllable by the control unit (83) to generate a label adapted to be coupled with the first container (24) and identifying said drug.

8. A weighing device (7) for weighing a first container (24) arranged, in a releasable manner, on a first support element (11),
the weighing device (7) being characterized in that it comprises:
a guide element (39), defining a path along a first axis (Z);
a movable element (40), coupled with the guide element (39) so as to move along said path;
a loading cell (32), having a first surface (32a) and a second surface (32b) opposite to each other along a first axis (Z), fixed to the movable element (40) through the second surface (32b) and configured to measure a weight force acting on the first surface (32a); and
at least one spacer (34), having a first end (34a) fixed to the first surface (32a) of the loading cell (32) and configured to support the first container (24) at a second end (34b) opposite to the first end (34a) along the first axis (Z),
wherein the movable element (40) is controllable in a first position of said path so that the spacer (34) does not support the first container (24), and in a second position of said path such that the spacer (34) supports the first container (24) so as to decouple it from the first support element (11), and
wherein the loading cell (32) is configured to continuously generate an indicative quantity of said weight force when the spacer (34) supports the first container (24).

9. A method (100) for drug preparation from a plurality of ingredients, the method (100) being implemented by means of an apparatus (1) according to claim 1 and being characterized in that it comprises, for each second container (22), the steps of:
fluidically connecting (106) the first container (24) to the second container (22);
decoupling (108) the first container (24) from the first supporting element (11) by moving the first movable element (40) from said first position to said second position so that the spacer (34) supports the first container (24);
transferring (110a), at least partially, the respective ingredient from the second container (22) into the first container (24) via said pumping means (21, 70, 80); and
continuously generating (110b), by the loading cell (32), the indicative quantity of said weight force while the spacer (34) supports the first container (24) and the respective ingredient is transferred from the second container (22) into the first container (24).

10. The method according to claim 9,
the apparatus (1) further comprising a base (3) having a surface (3a), orthogonal to the first axis (Z), to which the first support element (11) and the second support element (9) are coupled and to which the first guide element (39) is fixed,
the first support element (11) and the second support element (9) extending parallel to said surface (3a) and being arranged coaxially to each other with respect to a rotation axis (15) parallel to the first axis (Z),
the second support element (9) being axially interposed, relative to the rotation axis (15), between the first support element (11) and the surface (3a), and being rotatable relative to the base (3) about the rotation axis (15),
wherein the first support element (11) is rotatable relative to the base (3) about the rotation axis (15) and is configured to support, in a releasable manner, the first container (24) and at least a further first container (24),
the apparatus (1) further comprising first operating means controllable by the control unit (83) and configured to rotate, independently of each other, the first support element (11) and the second support element (9) relative to the base (3) about the rotation axis (15), so that a first selected container (24) and a second selected container (22) are arrangeable in respective angular positions so that they face the pumping means (21, 70, 80) and,
the method further comprising, for each second container (22), the step of arranging (104) the second supporting element (9) so that the second selected container (22) faces the pumping means (21, 70, 80).

11. The method according to claim 9, further comprising, for each second container (22), the steps of:
generating (108), by the loading cell (32), a tare quantity indicative of the weight force of the first container (24) while the spacer (34) supports the first container (24) and before the respective ingredient is transferred from the second container (22) into the first container (24);
associating (108), by the control unit (83), a corresponding tare weight (Wₜₐᵣₑ) to said tare quantity generated while the spacer (34) supports the first container (24) and before the respective ingredient is transferred from the second container (22) into the first container (24);
associating (110b), by the control unit (83), a corresponding gross instantaneous weight (W_{inst,gross}) to said quantity, generated while the spacer (34) supports the first container (24) and the respective ingredient is transferred from the second container (22) into the first container (24);
calculating (110b), by the control unit (83), a net instantaneous weight (W_{inst,net}) as a function of the gross instantaneous weight (W_{inst,gross}) and the tare weight (Wₜₐᵣₑ); and
determining (110c), by the control unit (83), whether the net instantaneous weight (W_{inst,net}) satisfies a predefined relation with a threshold weight (W_{threshold}).

12. The method according to claim 9, wherein the step of transferring (110a) the ingredient from the second container (22) into the first container (24) comprises controlling a pumping speed of the pumping means (21, 70, 80) based on said indicative quantity of the weight force.
